(19) United States
(12) Patent Application Publication
(10) Pub. No.: US 2026/0111588 A1
(43) Pub. Date: Apr. 23, 2026

(54) Systems and Methods for Secure Management of Generative Artificial Intelligence Engines

(71) Applicant: Intertrust Technologies Corporation, Berkeley, CA (US)

(72) Inventors: David Maher, Philadelphia, CA (US); Sami Ben Jamaa; Talal Shamoon, Berkeley, CA (US); Michael Manente, Sudbury, CA (US)

(73) Assignee: Intertrust Technologies Corporation, Berkeley, CA (US)

(21) Appl. No.: 19/469,283

(22) PCT Filed: Apr. 3, 2024
(86) PCT No.: PCT/US2024/022899

§ 371 Date: Sep. 25, 2025

Related U.S. Application Data
(60) Provisional application No. 63/456,790, filed on Apr. 3, 2023.

(51) Int. Cl. G06F 21/62; G06F 16/903; G06F 16/9038

(52) U.S. Cl. CPC G06F 21/6227; G06F 16/90335; G06F 16/9038

(57) ABSTRACT

Embodiments of the disclosed systems and methods provide for techniques for managing generative AI services that allow for generative AI models to better use confidential, proprietary, sensitive, and/or otherwise managed data while maintaining the security of such data. Various embodiments may provide for generative AI model training based on variable and/or otherwise tuned reliance on input training data sets and queries may leverage this differential training. Differential analysis techniques may be further employed to identify confidential data included in model outputs. In further embodiments, query and/or output labeling may be used in connection with access rights management techniques to manage access to proprietary information that may be included in model outputs. Embodiments of the disclosed systems and methods may be used in a variety of applications, use cases, and/or contexts, including in personalized medicine and differential diagnosis applications.

### CROSS-REFERENCE TO RELATED APPLICATIONS

This application claims the benefit of priority under 35 U.S.C. § 119 (e) to U.S. Provisional Application No. 63/456,790, filed Apr. 3, 2023, and entitled “SYSTEMS AND METHODS FOR SECURE MANAGEMENT OF GENERATIVE ARTIFICIAL INTELLIGENCE ENGINES,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing generative artificial intelligence (“AI”) engines. More specifically, but not exclusively, the present disclosure relates to systems and methods for managing generative AI engines that use confidential, proprietary, and/or otherwise managed data while maintaining the security of such confidential data.

Generative AI is a relatively broad term that may encompass various forms of AI and/or associated AI engines that generate output using a trained model. Generative AI may be used in a variety of contexts including, for example and without limitation, e-commerce, healthcare, financial services, etc. With increasing compute power, larger training data sets, and/or updated model architectures, more sophisticated generative AI engines are being developed with increased potential for market disruption.

While sophisticated generative AI models are becoming more relevant, they are less immediately useful in domains that use confidential, proprietary, sensitive, and/or otherwise managed information. For example, in the corporate context, because generative AI engines are often trained using public data with limited access to confidential and/or managed corporate data (corpus) and/or corporate knowledge (human), their generated outputs may be less valuable to specialized corporate entities. Moreover, corporate entities may be less willing to allow their proprietary and/or otherwise confidential data to be used to train and/or otherwise improve generative AI models for fear of inadvertently disclosing sensitive information externally or internally to unauthorized parties.

Embodiments of the disclosed systems and methods provide for techniques for managing generative AI engines that allow for generative AI models to better use confidential, proprietary, sensitive, and/or otherwise managed data while maintaining the security of such confidential data. This may allow generative AI engines consistent with various aspects of the disclosed embodiments to use a data trove that may sit relatively untapped in certain file systems and/or manage how such data may be exchanged and/or processed by generative AI engines, potentially with other entities, while maintaining the security and/or confidentiality of such data and/or derivatives of the data. This may, among other things, bring new dimensions to practices associated with governance, legal, change management, and/or business improvement that leverage generative AI.

### BRIEF DESCRIPTION OF DRAWINGS

The inventive body of work will be readily understood by referring to the following detailed description in conjunction with the accompanying drawings, in which:

FIG. 1A illustrates a non-limiting example of a generative AI model weighted training process using proprietary and public data consistent with certain embodiments of the present disclosure.

FIG. 1B illustrates a non-limiting example of a generative AI model weighted query process consistent with certain embodiments of the present disclosure.

FIG. 2A illustrates a non-limiting example of a differential training process for generative AI models consistent with certain embodiments of the present disclosure.

FIG. 2B illustrates a non-limiting example of a query process for generative AI models employing differential output analysis consistent with certain embodiments of the present disclosure.

FIG. 3A illustrates a non-limiting example of a generative AI model training process consistent with certain embodiments of the present disclosure.

FIG. 3B illustrates a non-limiting example of a generative AI model query process employing access management techniques to labeled model outputs consistent with certain embodiments of the present disclosure.

FIG. 4A illustrates a non-limiting example of a generative AI model training process consistent with certain embodiments of the present disclosure.

FIG. 4B illustrates a non-limiting example of a generative AI model query process employing access management labeled queries issued to the generative AI model consistent with certain embodiments of the present disclosure.

FIG. 5 illustrates a flow chart of a non-limiting example of a generative AI model query process consistent with certain embodiments of the present disclosure.

FIG. 6 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all these details. Moreover, for the purpose of clarity, certain technical material that is known in the related art has not been described in detail in order to avoid unnecessarily obscuring the disclosure.

The embodiments of the disclosure may be understood by reference to certain drawings where, in certain instances (but not necessarily all), like parts may be referred to by like numerical references. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure but is merely representative of possible embodiments of the disclosure. In addition, the steps of any method and/or process disclosed herein do not necessarily need to be executed in any specific order, or even sequentially, nor need the steps be executed only once, unless otherwise specified. Moreover, it will be understood that, as used herein, a process and/or method that is described as being based on some information is not necessarily exclusively based on the information, but indeed may be based at least in part on the information and/or a portion thereof.

Embodiments of the disclosed systems and methods provide mechanisms for managing the use of proprietary, confidential, sensitive, and/or otherwise managed data (which for purposes of simplicity may be generally referred to herein as proprietary data) in connection with generative AI models and/or engines. Various embodiments may, among other things, allow for generative AI model training based on variable and/or otherwise tuned reliance on input training data sets. For example, proprietary and/or public data sets and/or subsets thereof may be associated with certain labels, tags, and/or the like (which may be generally referred to herein for purposes of simplicity as labels), potentially added during a pre-processing process. Data having certain labels (e.g., proprietary labels and/or the like) may be weighted and/or otherwise relied upon to relatively different degrees during model training based on associated training parameters and/or weighting.

When the trained generative AI model is later queried, queries may be associated with parameters and/or indications of relative weightings of training data the querying user would like the generative AI model to rely upon when generating an output. For example, a query may be associated with an indication that only public training data should be relied upon when generating an output responsive to the query, an indication that only proprietary training data should be relied upon when generating an output responsive to the query, an indication of a relative degree to which public and/or proprietary training data should be relied upon when generating an output responsive the query, and/or the like.

In certain embodiments, a single specialized generative AI model maybe trained and allow for queries associated with parameters and/or indications of relative weightings between training data the querying user would like the generative AI model to rely upon when generating an output. In further embodiments, multiple AI models may be trained with varying relative weights of proprietary and/or public data. When a user issues a query, a generative AI model of the plurality of trained models may be selected based on information associated with the selected model that matches and/or is within a threshold level of similarity to the parameters and/or indications of relative weightings associated with the query. In this manner, a trained model may be selected that is well matched to a particular query and/or associated indications. In further embodiments, and as described in more detail below, models may be selected based on rights associated with a querying user. In some embodiments, from the perspective of the user, it may appear that a single generative AI model is being queried, with selection of the particular trained AI model used to generate an output being performed automatically by the associated generative AI model service.

Further embodiments of the disclosed systems and methods may employ differential analysis techniques to compare outputs generated by a plurality of generative AI models trained on different data sets. For example, a first generative AI model may be trained on a combination of public and proprietary data sets and a second generative AI model may be trained on public data sets only. A query may be issued to both models and their resulting outputs may be compared to identify proprietary information that is included in the output from the first model. Access to associated proprietary information by a particular user may be managed using access management techniques.

In yet further embodiments, labelling of queries and/or model outputs may be used to manage access to information generated by trained AI models. For example, in some embodiments, proprietary and/or public data sets used to train a generative AI model may be labeled in a manner such that the labelling and/or derivatives thereof is retained by the generative AI model. When queried, if the trained model relies on labeled data in generating an output, the output may be labeled and/or otherwise provided with some indication to reflect the model's reliance on labeled data. Access rights management techniques may be then employed to manage whether the entire labeled output and/or subsets thereof is issued to the user responsive to the query.

In other embodiments, queries issued to a generative AI model may be managed using access rights management techniques. For example, a user may issue a query that may be processed by a generative AI service based on associated user access rights. For example, if a user does not have access rights to certain data subsets, the generative AI service may add certain labeling and/or otherwise modify the query to reflect such access rights. The generative AI model may generate an output responsive to this labeled and/or modified query, which may be then returned to the querying user.

Although various embodiments, examples, applications, and/or use cases described herein may be described in the context of managing generative AI models in connection with proprietary, confidential, and/or otherwise sensitive corporate data, it will be appreciated that the disclosed systems and methods are not so limited. Indeed, embodiments of the disclosed systems and methods may be used in connection with any type of proprietary, confidential, sensitive, and/or otherwise managed data and associated applications, use cases, and/or contexts.

### Generative AI in the Corporate Context

Corporate business data grows with time and, in many conventional paradigms, is rarely cleansed, curated, and/or visited after its initial creation. Even with file categorization techniques, data management software, and/or embedded corporate search engines, certain corporate data may be difficult to locate and/or use. Employees often spend a relatively significant amount of time searching, collating, and/or collecting data from different sources to create new and/or updated versions of business document. This work may span different databases, file stores, intranets, and/or mail systems. Navigating this maze of files and/or checking documents based on their titles and/or metadata is time consuming, with many files containing outdated information and/or information that is not relevant to a particular context. In many instances, employees may choose to create a document from scratch rather than leveraging previously generated documents and/or other information, resulting in lost efficiencies.

New members of an organization may spend years digging through a panoply of corporate documents as part of an onboarding learning curve. Many documents, however, refer to older document versions, sometimes in specific chronological order. For example, documents used for auditing, controls, proposals, and/or the like often refer and/or relate to earlier documents. Corporations may struggle to keep experts with institutional corporate knowledge on its payroll, with their departure creating significant human knowledge asset deficiencies.

In many instances, the larger a corporation, the slower information dissemination may occur, with more meetings required to make decisions that were previously shared with various groups. This may result in an increase in the number of documents and/or files created, with increased time burdens to clarify business actions and/or facilitate the decision-making process.

Businesses may frequently turn to consulting firms for support in collecting information, data, and/or insights to determine necessary actions. Much of this information may be obtained from existing data stores, which may incur significant time and/or effort costs. Additionally, finding the appropriate resources for this type of investigation and/or due diligence can be challenging. The objective and comprehensive analysis of such data may rely on human factors, leaving the validity of suggested actions open to question as it is difficult to validate suggestions thoroughly by revisiting source data.

Corporate governance may place great importance on data content management, security, and/or intended recipients. Effective governance may develop associated policies, rules, and/or systems to ensure data usage is confined to a secure perimeter and is well monitored. Exchanging data with third parties may be subjected to stringent rules. Users may be left to their judgement to find ways to exchange data with relevant parties and may find themselves circumventing rules and/or requesting special authorization to do so. Besides being time consuming, determining the validity of exchanged data and/or investigating leaks of data may take significant resources to audit and discover.

Corporate data may span different types, formats, data sources, and/or confidentiality levels. Non-limiting examples of corporate data types, formats, confidentiality levels, and/or usability and/or accuracy levels are presented below.

| | | Confidentiality | Usability/ |
|---|---|---|---|
| Type | Format | Level | Accuracy |
| Board/Executive | Minutes/Presentations | Very high | High |
| Contracts/Legal | Document | Very high | High |
| External (bidding, | Document/Presentation | Medium | High |
| purchasing, RFP) | | | |
| Internal | SharePoint/Intranet/ | Mixed | Limited |
| | Documents | | |

When corporate data is used and/or transformed for training generative AI engines, there is a chance that it may eventually become accessible by the public, and it may be difficult to claim copyright infringement and/or legal rights to such transformed data. Moving forward, many corpuses of data and/or generative AI training models may be developed by various corporations, with different degrees of accuracy, for lack of standards and/or relatively high costs associated to such endeavors.

### Trusted Secure Layer(s) and Management of Generative AIs

Consistent with embodiments disclosed herein, a trusted and/or otherwise secure layer may be used to connect corpuses of data (which in certain instances herein may be generally referred to as data and/or data sets) and/or associated trained models together in a manner that protects the rights of associated knowledge owners. In various embodiments, a generative AI engine may be trained on a proprietary corpus of data, which in some non-limiting examples may encompass a variety of corporate data (e.g., board of directors' minutes, bidding proposals, etc.). The generative AI engine may provide corporate users access to information and/or facilitate collation, cross-checking, summarization, and/or building of documents with more accurate data (e.g., value, temporal, context, validity, confidentiality, and/or legal data and/or the like, etc.). As detailed above, generative AI training data corpuses may extend beyond a corporate data corpus and rely on public and/or other parameter sets, including public data, with models enhanced by the appropriately weighted and/or annotated proprietary data corpus.

In various embodiments, mechanisms of the disclosed systems and methods may allow for parameterizing and/or weighting data used to train a generative AI engine. For example, embodiments of the disclosed systems and methods may allow for interfacing with generative AI model engines, such as available language learning models (“LLMs”), to enhance a user experience and/or reduce an amount of “general” and/or otherwise public and/or less sensitive and/or confidential data to supplement the corporate corpus of data used by the engines. In this manner, generative AI models may be leveraged, but tailored to rely on a corporate corpus of data in training more pronouncedly than general public data. This may, among other things, provide more accurate output derived from the corporate data corpus.

In various embodiments, specialized approaches to a discriminatory training phase of a generative AI engine may be used. Such an approach may, for example and without limitation, identify rights-managed information used in model training and test the model's ability to produce abstracts of such information that avoids and/or appropriately labels confidential and/or otherwise sensitive information.

In certain embodiments, a trusted exchange protocol and layer may be used to allow corporations to exchange certain information (e.g., know-how) information without revealing certain other sensitive industry secrets. This may facilitate, among other things, corporations to monitor the use of a subset of their corporate data corpus in a transparent and trusted fashion while maintaining auditability, trackability, and/or data exchange in an accurate and/or monitored fashion.

In connection with some embodiments of the disclosed systems and methods, a training methodology may be used allowing for the creation of a multi-entity data corpus to be created, where data from a heterogenous set of corporations may be used. Outputs generated by the generative AI engines may annotate sections and/or portions of a response with rights labels and/or redact a response based on credentials of an entity providing the query to the engine.

Further embodiments disclosed herein may provide an architecture allowing for entities to build and/or deploy their own generative AI engines and for developers to create applications to facilitate the use of proprietary data corpuses in a more intuitive way. For example and without limitation, applications may be built allowing users to create documents (e.g., slideshow documents) with photos and/or diagrams from a number of disparate documents. Mechanisms for renumerating certain involved entities and/or stakeholders may also be used.

Embodiments of the disclosed systems and methods provide for variable, dynamic, and/or otherwise adjustable reliance on input training data sets. In certain embodiments, training input data sets may be labeled to differentiate whether the constituent data is proprietary data and/or public data, and/or various gradations and/or levels of the same. This label information may be used in connection with dynamically training generative AI models using the associated data sets and/or querying the trained AI models.

Although various embodiments, examples, and/or uses cases herein refer to data sets being either proprietary and/or public data, it will be appreciated that many different levels of proprietary data and/or public data may exist, with different levels of access privileges, rights, and/or associated sensitivity and/or confidentiality. For example, as discussed above, within the context of corporate data, executive meeting minutes and/or legal contracts may have a relatively high level of confidentiality, whereas corporate documents generated by entry-level employees may have a lower level of confidentiality (although not necessarily being considered public data for disclosure outside the company).

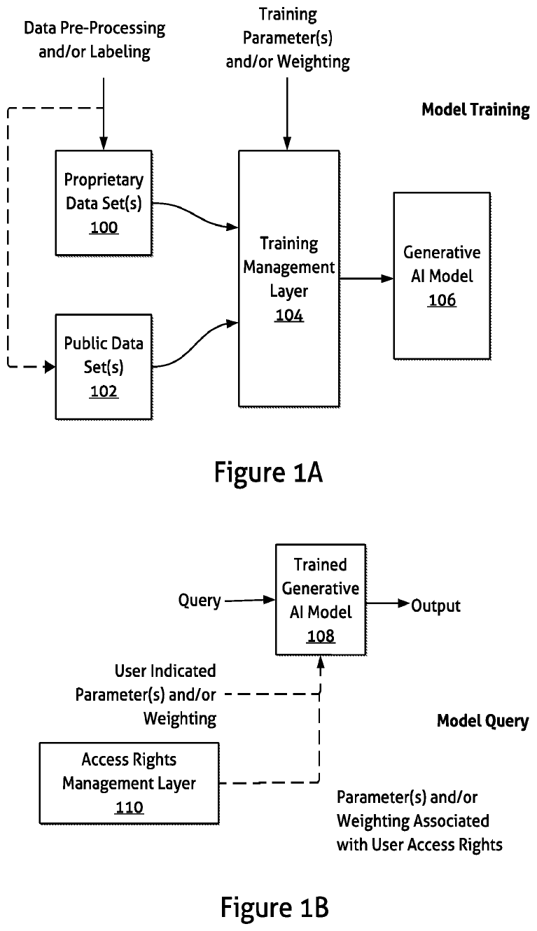

FIG. 1A illustrates a non-limiting example of a generative AI model weighted training process using proprietary and public data consistent with certain embodiments of the present disclosure. As illustrated, one or more data set corpuses 100, 102, which in some embodiments may comprise data associated with multiple organizations, may be used to train a generative AI model 106. The proprietary data sets 100 and/or public data sets 102 and/or their constituent data may be pre-processed and/or labeled consistent with certain embodiments of the disclosed systems and methods. In some implementations, one or more proprietary data labels may be used to label the proprietary data sets 100. In further implementations, both proprietary data sets 100 and public data sets 102 may be labeled.

Consistent with various aspects of the disclosed embodiments, a model training management layer 104 may be used for partitioning, parameterizing, and/or weighting data used to train the generative AI model 106. For example, and without limitation, embodiments of the disclosed systems and methods may allow for improved training and/or associated response generation from a generative AI model by tailoring an amount of “general” and/or otherwise public and/or less sensitive and/or confidential data to supplement the proprietary corpus of data used to train the generative AI model 106. In this manner, generative AI engines may be leveraged by services, organizations, and/or individuals concerned with maintaining the confidentiality of their proprietary information, with models trained to rely more on a proprietary corpus of data in training more pronouncedly relative to a more expansive public data corpus, thereby providing more accurate output derived, at least in part, from training from the proprietary data corpus.

In various embodiments, the model training management layer 104 may be provided with training parameters and/or weighting information to determine how the generative AI model 106 should be trained based on the input data sets 100, 102. For example, the training parameters and/or weighting information may indicate that the training process should rely more heavily on the proprietary data sets 100 than the public data sets 102, that the training process should rely more heavily on the public data sets 102 than the proprietary data sets 100, that the training processing should rely equally on the proprietary data sets 100 and/or the public data sets, and/or any other variation of the same.

In some embodiments, the training parameters and/or weighting information (and/or derivative information) may survive the training process of the generative AI model 106 and, as discussed in more detail below, may be used in connection with querying a single trained model and/or adjusting reliance by the model on various training data when generating output(s) as desired by a querying user. In this manner, a single specialized generative AI model maybe trained and allow for queries associated with parameters and/or indications of relative weightings between training data the querying user would like the generative AI model to rely upon when generating an output.

In further embodiments, the training parameters and/or weighting information may be used to train multiple generative AI models (which for the purposes of simplicity and explanation, may be illustrated herein as a single trained generative AI model that comprises multiple constituent trained models). Each model of the plurality of trained generative AI models may be associated with varying relative reliance of proprietary data sets 100 and/or public data sets 102, with information indicating the trained models' reliance on data sets 100, 102 being associated with the models and referenceable post-training during model querying. As discussed in more detail below, using this referenceable information associated with the models, a trained model of the plurality of train models may be selected based on user-specified parameter(s), weighting, and/or preferences associated with a query.

FIG. 1B illustrates a non-limiting example of a generative AI model weighted query process consistent with certain embodiments of the present disclosure. As shown, a user may issue a query to a trained generative AI model 108 which, based on the query, may generate an output that may be provided to the querying user. Consistent with certain embodiments disclosed herein, when issuing a query, a user may provide parameters and/or indications of relative weightings between training data the querying user would like the trained generative AI model 108 to rely upon when generating the output. The trained generative AI model 108 may generate an output responsive to the query and the indicated parameters and/or indications of relative weightings.

In embodiments where a plurality of trained AI models may be generated based on varying training parameters and/or weighting information, a model of the plurality of trained models may be selected based on the parameters and/or indication of relative weightings of training data the querying user would like the trained generative AI model 108 to rely upon when generating the output. For example, a querying user may specify via user indicated parameters and/or weightings associated with a query that they wish for an output to be generated based on a model trained using 75% public data and 25% proprietary data. Similarly, a user may specify that they wish for an output to be generated based on a model trained using entirely public data, a model trained using entirely proprietary data, and/or any relative combination of the same corresponding to and/or within a threshold associated with one of the available trained AI models.

A model trained on the indicated combination of data (and/or within a threshold level of similarity to this indicated combination) may be selected from the plurality of available trained models and used to generate the output in response to the user's query. In this manner, a trained model may be selected that is well matched to a particular query and/or associated indications.

In some embodiments, parameters and/or weighting information associated with a user query may be provided directly by a user in conjunction with and/or separate from the query. In certain embodiments, such information may be specified by a user as part of standard user settings when interacting with a generative AI service providing the trained generative AI model. In further embodiments, parameters and/or weighting indications may be provided by an access rights management layer 110 enforcing relative rights to access proprietary data sets and/or generative AI models trained using the same. For example and without limitation, when a user logs in to a generative AI service and/or an associated system and/or service, access rights permissions information associated with the user may be provided to the trained generative AI model 108 that may be used in connection with generating outputs based on queries from the user. The access rights management layer 110 may, in some embodiments, manage profile information associated with one or more users that specify a user's relative rights and/or permissions to access and/or use proprietary data sets 100 and/or models trained thereon when interacting with the trained generative AI model 108 and/or other models. In this manner, a user may only be permitted to access and/or otherwise use the trained generative AI model 108 in accordance with their relative rights and/or permissions specified by the access rights management layer 110.

In some implementations, a user may have rights to access models that have been trained on certain classified or sensitive information, but certain queries from that user may not necessarily require use of such information. In certain embodiments, the access rights management layer 110 can act as an expert system and/or AI system that interprets and/or clarifies a user's query goal before submitting it to an associated selected trained model of a plurality of trained models. In at least one non-limiting example, a user with access credentials that enable access to a model that has been trained on forward-looking, not yet published financial data may ask in a query “What is the latest profit forecast for division xyz?” The access rights management layer 110, if trained to recognize such a query as having potentially different results between the two models of the trained plurality of models, may be configured to ask a clarifying question to the user, such as: “Would you like to see the latest publicly available financial projections for division xyz? Or the latest private projections?”

An access rights management layer 110 configured in above-described manner could then direct the request to an associated trained model, assuming that the appropriate access rights are present for use of that model. In some implementations, to mitigate data leakage, the service may be configured to issue clarifying questions to queries in circumstances where the user has rights to access both models. In this manner, the existence of data that requires authorized access may not be inadvertently disclosed to unauthorized users.

Embodiments of the disclosed systems and methods may account for and/or include certain functionalities and/or considerations that include, for example and without limitation, one or more of:
Training Data Corpus-Generative AI engines may utilize significant amounts of training data to learn patterns and/or generate outputs. A number of suitable methods may be used to allow a generative AI engine to read data for training (e.g., read data from SharePoint and/or Microsoft documents—MS Graph API, Python and/or SharePoint REST API, etc.). In certain embodiments, more sensitive and/or confidential data (e.g., corporate data) may be handled more securely, potentially leveraging functionality of trusted data management platforms and/or services.
Data Pre-Processing—In various embodiments, data cleansing, normalization, and/or identifying master data, confidentiality labeling, and/or other data processing operations may be performed. In certain embodiments, style and/or tone may be added to text to improve model training and improve associated output.
Model Architecture—In various embodiments, the model architecture of a generative AI engine may be tailored to achieve certain training input processing and/or output generation goals. For example and without limitation, if photos, videos, and/or audio records are included in a training data corpus, higher dimensional architecture design may be employed to handle any unstructured aspects of the data. For example and without limitation, machine translation of audio content and/or character recognition of text, which may comprise text included in video and/or image content, may be used in connection with model training.
Optimization Algorithms(s)—In some embodiments, an optimization algorithm may be used to adjust model parameters to improve its performance. There may be a number of algorithms that may be used including, for example, and without limitation, ADAM, Stochastic Gradient Descent (“SGD”), and/or Reinforcement Learning (“RL”).
Data Privacy and Security—Corporate data may include sensitive information that may be protected. In certain embodiments, data used to train a generative AI engine model may be secured, with its use managed for the purpose of model training. In some embodiments, model sensitivity may be tagged to allow for management later on.
Trust Interface—Internal and/or external exchanges may include a layer that identifies if an output generated by a trained generative AI engine infringes and/or otherwise impacts the confidentiality of confidential and/or secure data.
Deployment and Maintenance—The trained generative AI model may be deployed, maintained, and/or monitored to determine whether the trained generative AI engine generates outputs suitable for intended use cases.
Adaptive Training—In some embodiments, adaptive training techniques may be employed, allowing for new data to be included in a training corpus without needing to re-train the model from scratch.

Consistent with various embodiments disclosed herein, a trust label and/or tag may be embedded encapsulating confidential, sensitive, and/or critical data and/or information during a data cleaning and/or tokenization process and/or during transformation when training parameters are adjusted to convey a “trust” factor of the outcome. In some embodiments, a result may be redacted and/or sensitive portions may be replaced with similar (e.g., public) data.

In certain implementations, embodiments of the disclosed systems and methods may allow subject matter experts to access a larger and richer set of data in context that is relevant to a particular industry, rather than using only their own data which alone may be less valuable. A layer where “API-like” filters and “discriminators” may be used to deliver information and/or answer queries while vouching for not disseminating responses that may comprise trusted and/or sensitive content. Transactions may be recorded for purposes of monetization. In some embodiments, feedback processes may be added to enrich a data corpus for a specific industry.

### Management of Generative AI Models Using Differential Training and Analysis

Certain embodiments of the disclosed systems and methods may employ differential analysis techniques to compare outputs generated by a plurality of generative AI models trained on different data sets (e.g., public and proprietary data sets). For example, in some embodiments, a plurality of generative AI models may be trained on different data sets (and/or different combinations of data sets). Queries may be issued to the plurality generative AI models, potentially in parallel, and resulting outputs may be compared to determine if any proprietary information is included in the outputs (e.g., whether proprietary information has “leaked” through the model when generating the output). Access to any proprietary information included in the output(s) may be managed using suitable access management techniques as described herein (e.g., output response filtering, tagging, labelling, and/or the like).

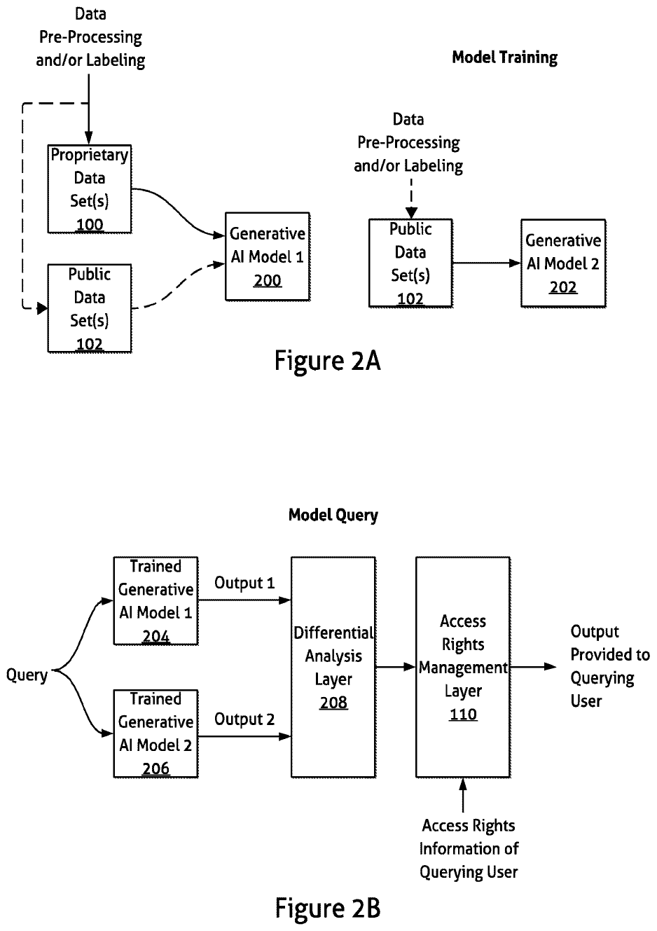

FIG. 2A illustrates a non-limiting example of a differential training process for generative AI models consistent with certain embodiments of the present disclosure. As shown a proprietary data set 100 and a public data set 102 may be used to train a first generative AI model 200. The proprietary data sets 100 and/or public data sets 102 and/or their constituent data may be pre-processed and/or labeled consistent with certain embodiments of the disclosed systems and methods. Similarly, the public data set 102, which may be pre-processed and/or labeled (and/or have constituent data that is pre-processed and/or labeled), may be used to train a second generative AI model 202. In this manner, the first generative AI model 200 may be trained, at least in part, using the proprietary data set(s) 100 and the second generative AI model 202 may be trained only using the public data set 102. Although only two generative AI models 200, 202 are shown for purposes of illustration and explanation, it will be appreciated that any suitable number of differentially trained generative AI models may be used in connection with the disclosed embodiments. Indeed, it will be appreciated that, in certain embodiments, any suitable number of generative AI models may be trained on different of training data sets comprising different combinations of constituent data sets (e.g., public and/or private data sets and/or data sets with more granular labeling, as discussed in more detail below below).

Consistent with embodiments disclosed herein, differential analysis techniques may be used to compare outputs generated by the first trained generative AI model 204 and the second generative AI model 206. FIG. 2B illustrates a non-limiting example of a query process for generative AI models 204, 206 employing differential output analysis consistent with certain embodiments of the present disclosure. A query may be issued to the first generative AI model 204 and the second generative AI model 206 and associated outputs may be generated by the models 204, 206. In various embodiments, the queries may be issued in parallel, although other suitable methods of querying the respective trained models 204, 206 may also be employed.

The respective outputs—Output 1 and Output 2—may be provided to a differential analysis layer 208 of the generative AI service. In various embodiments, the differential analysis layer 208 may compare the outputs and determine if any proprietary information and/or derivatives thereof is included in the outputs. For example, in some embodiments, if the output of trained generative AI model 204, trained using both proprietary data sets 100 and public data sets 102, includes certain information that is not included in the output of trained generative AI model 206, trained using only the public data sets 102, the differential analysis layer 208 may determine that the identified information is likely derived from the proprietary data sets 100. In this manner, the “leakage” of proprietary information included in the proprietary data sets 100 into outputs generated by the first trained generative AI model 204 may be identified, and access to such information may be managed.

A suitable variety of differential comparison methods, techniques, and/or methodologies may be used in connection with various disclosed embodiments, including more simplistic comparative techniques as well as more advanced cluster-based differential analysis. For example, although a single output is illustrated in connection with each of the trained models 204, 206, it will be appreciated that in further embodiments, the trained models 204, 206 may be queried multiple times to generate multiple output responses which may be used in the comparison process performed by the differential analysis layer 208.

Access to associated proprietary information by a particular querying user may be managed using access management techniques employed by the access rights management layer 110. For example, the access rights management layer 110 may use access rights and/or permissions information associated with the particular querying user, which may be provided by a separate access rights management service and/or database and/or be managed directly by the access rights management layer 110 of the generative AI service, to determine whether the user is permitted to access certain proprietary information included in the generated output(s) as identified by the differential analysis layer 208.

For example, if the access rights management layer 110 determines that a querying user is permitted access to the proprietary data sets 100, the output provided to the user may reflect the output provided by the first trained generative AI model 204. If, however, the access rights management layer 110 determines that a querying user is not permitted access to the propriety data sets 110, the output provided to the user may reflect the output provided by the second trained generative AI model 206.

In further embodiments, the access rights management layer 110 may, based on the access rights information associated with the querying user, modify, filter, and/or otherwise transform one or more of the outputs provided by one or more of the trained generative AI models 206 before providing the output to the user. For example, the access rights management layer 110 may filter at least a portion of an output (e.g., filter to remove proprietary information), label and/or tag at least a portion of an output (e.g., label proprietary information with a “proprietary” and/or “confidential” tag, potentially even to users who are permitted access to the information), and/or the like. In this manner, in various implementations, a user may only be permitted access to information generated based on proprietary data sets 100 in accordance with their relative rights and/or permissions specified by the access rights management layer 110.

Differential model training and analysis as detailed herein may be used in a variety of use cases, applications, and/or contexts. In at least one non-limiting example, differential analysis may be used in differentiated marketing for a company that regularly interacts with its customers. Based on customer interactions, customers may be categorized, and proprietary data sets may be divided into N groups corresponding to the categories. Multiple generative AI models may be trained based on each categorized group of proprietary data sets in addition to a model being trained on a public and/or non-proprietary dataset—that is, N+1 models may be trained.

Queries may be submitted to the N+1 trained models and resulting outputs may be analyzed using text analysis techniques including, for example and without limitation, differences identified in the frequency, presence, and/or juxtaposition of words in the outputs. Based on this analysis, insights may be gained from the results of inclusion of various proprietary data in the N data groups used to train the models including, for example and without limitation, an understanding of customer information drawn from private interactions with customers in email and/or chats. These insights may be used for in a variety of contexts including, for example and without limitation, in product improvement where new features may be identified and/or prioritized, in marketing communications to determine what kinds of emotions different classes of customers respond to, and/or the like. Other methods of differential analysis may be used such as, for example and without limitation, text clustering.

### Management of Generative AI Models Using Output Tagging

In various disclosed embodiments, generative AI models may employ labeling techniques where outputs that are generated based on labeled training data are themselves labeled to indicate such reliance. For example, proprietary and/or public data sets used to train a generative AI model may be labeled and model training processes designed in a manner such that the labelling and/or derivatives of the same is retained by the generative AI model in a suitable manner. When queried, if the trained model relies on labeled data in generating an output, the output may be labeled and/or otherwise output with some indication to reflect the model's reliance on the labeled data. Access rights management techniques may then be employed to manage whether the entire labeled output and/or subsets thereof are issued to the user responsive to their query.

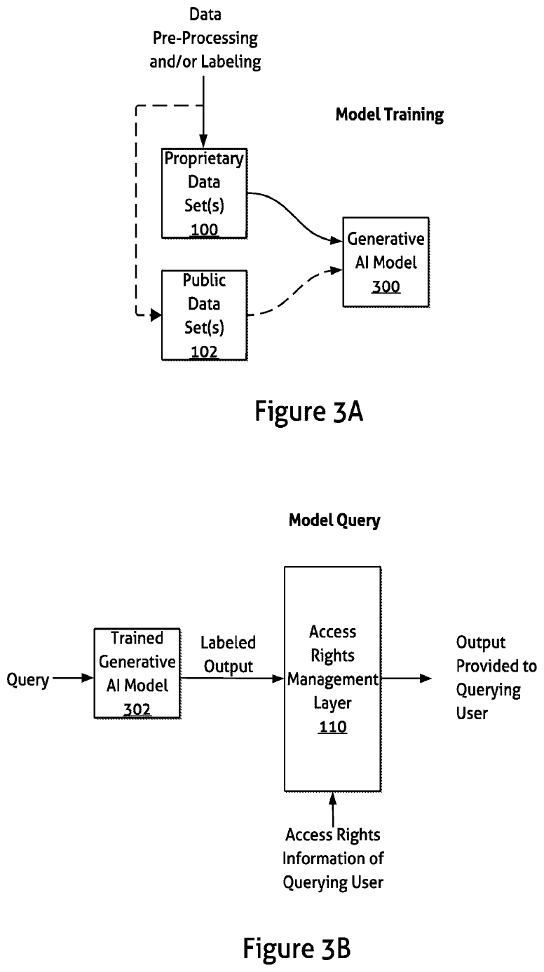

FIG. 3A illustrates a non-limiting example of a generative AI model training process consistent with certain embodiments of the present disclosure. As shown a proprietary data set 100 and a public data set 102 may be used to train a generative AI model 300. The proprietary data sets 100 and/or public data sets 102 and/or their constituent data may be pre-processed and/or labeled consistent with certain embodiments of the disclosed systems and methods.

FIG. 3B illustrates a non-limiting example of a trained generative AI model query process employing access management techniques to labeled model output consistent with certain embodiments of the present disclosure. A query may be issued to the trained generative AI model 302 and an associated output may be generated by the model 302. Consistent with embodiments disclosed herein the output and/or portions thereof may be associated with one or more labels. Labels associated with the output may provide an indication of whether the trained model 302 relied on labeled training data to generate the labeled output data and/or portions thereof.

The labeled output may be provided to an access rights management layer 110 of the generative AI service, which may manage access to any proprietary information included in the labeled output using suitable access rights management techniques. For example, the access rights management layer 110 may use access rights information associated with the particular querying user, which may be provided by a separate access rights management service and/or database and/or be managed directly by the access rights management layer 110, to determine whether the user is permitted to access the information included in the labeled output that is indicated as being proprietary.

The access rights management layer 110 may among other things, modify, filter, and/or otherwise transform the labeled outputs and/or portions thereof before providing the output to a querying user in accordance with applicable access rights management determinations. In some implementations, even if a user is permitted access to proprietary information included in labeled outputs generated by the grained generative AI model 302, the output provided to the querying user may retain such labels so that the user can readily identify that the output and/or portions thereof are marked as including proprietary information (e.g., proprietary information in outputs provided to a user may be labeled with a “proprietary” and/or “confidential” tag and/or the like).

In various embodiments, labeling may employ the use of keywords. In certain implementations, keywords may be identified and/or otherwise selected based on a pre-analysis of a data set used in training. After being identified, the keywords may be applied to the data set and/or portions thereof. In certain embodiments, labels may be used in connection with generating summaries, potentially using techniques where labels and/or keywords are graphed in a connected matter. Consistent with embodiments disclosed herein, metatags and/or labels may be used to select and/or prioritize text that should be featured or suppressed when generating a response to a query. In some embodiments, labels may be used in an iterative analysis of unstructured text datasets to identify associated categories.

### Management of Generative AI Models Using Query Tagging

Queries issued to a generative AI model may, in some embodiments, be managed using access rights management techniques. For example, a user may issue a query to a generative AI service that may be pre-processed and/or modified based on associated user access rights. If a user does not have access rights to certain data subsets, the generative AI service may add certain labeling and/or otherwise modify the query to reflect such access rights. For example, if a user is not permitted access to a proprietary data set or a subset thereof, a query issued to the trained generative AI model may be modified by the service to reflect that any generation of an output in response to the query should not rely on and/or should otherwise exclude the proprietary data set and/or subset of the same. The generative AI model may then generate an output responsive to this labeled and/or modified query, which may be then returned to the querying user.

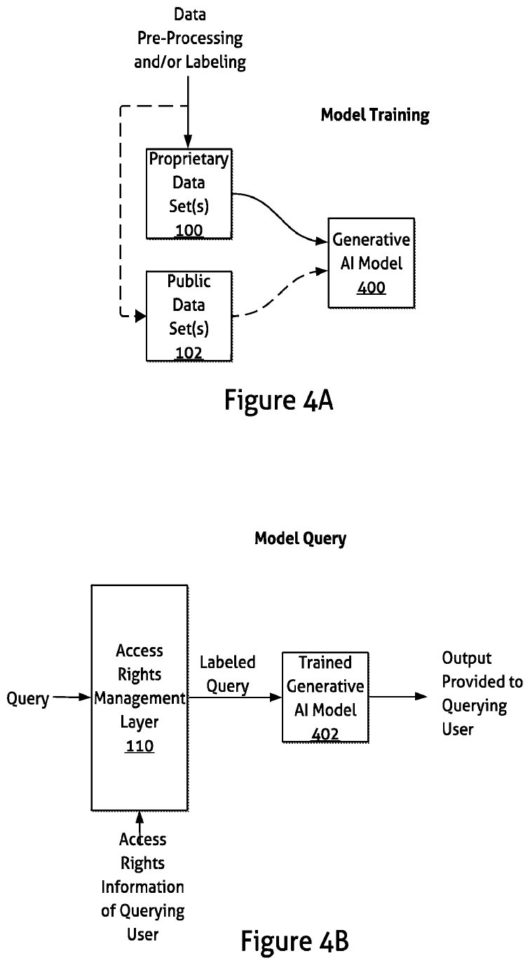

FIG. 4A illustrates a non-limiting example of a generative AI model training process consistent with certain embodiments of the present disclosure. As shown, a proprietary data set 100 and a public data set 102 may be used to train a generative AI model 400. In some embodiments, the proprietary data sets 100 and/or public data sets 102 and/or their constituent data may be pre-processed and/or labeled consistent with certain embodiments of the disclosed systems and methods.

FIG. 4B illustrates a non-limiting example of a generative AI model query process employing access management label queries issued to the trained generative AI model consistent 402 with certain embodiments of the present disclosure. In various embodiments, queries to a trained generative AI model 402 offered by a generative AI service may be received by an access rights management layer 110 for pre-processing. The access rights management layer 110 may label, modify, and/or otherwise transform the query and/or portions thereof before providing the query to the trained generative AI model 402 in accordance with applicable access rights management determinations.

Access rights associated with a particular user and/or system may be reflected in access rights information associated with the querying user, which may be provided to the access rights management layer 110 by a separate access rights management service and/or database and/or be managed directly by the access rights management layer 110 of the generative AI service, to determine whether the user is permitted to access certain proprietary information. For example, when a user logs in to a generative AI service and/or an associated system and/or service, access rights permissions information associated with the user may be provided to and/or otherwise accessed by the access rights management layer 110 that may be used in connection with generating labeled queries based on associated user rights and/or permissions.

Based on the access rights information associated with the querying user, the access rights management layer 110 may label, modify, and/or otherwise transform the query and/or portions thereof before providing the query to the trained generative AI model 402 to reflect the access rights and/or permissions of the querying user. For example, the access rights management layer 110 may determine that a querying user does not have access rights to proprietary data and/or a subset thereof and may therefore modify the query to add a label indicating that the trained generative AI model 402 should generate its output without relying on any of the restricted proprietary data. In another example, if the access rights management layer 110 determines that a querying user has full access rights to proprietary data and is associated with an indicated preference for increased reliance on proprietary data when responding to queries, the access rights management layer 110 may modify the query to add a label indicating that the trained generative AI model 402 should generate its output by relying more heavily on proprietary training data. As discussed herein, the modified query may, in some embodiments, be used to select a trained model of a plurality of trained models based on associated access rights of the querying user. It will be appreciated that a variety of modifications, transformations, and/or labelling may be performed by the access rights management layer 110 suitable to a variety of access management determinations and/or user preferences.

The trained generative AI model 402 may generate an output responsive to the transformed, labeled, and/or modified query, which may be then returned to the querying user. In certain embodiments, any labeling, modifications, and/or transformation of queries performed by the access rights management layer 110 may not be perceived by the querying user. In this manner, access rights management determinations may be performed and/or enforced consistent with a user's access rights and/or permissions without the user perceiving the specific access rights determinations being made. In further embodiments, access rights management determinations performed by the access rights management layer 110 may be transparent to the querying user.

### Use Case Examples Implementing Trusted Generative AI

Embodiments of the disclosed systems and methods may be used in a variety of applications, contexts, and use cases including, for example and without limitation, one or more of:
Board of Directors and Executive Meetings—Generative AI models may be used to provide a summary of past resolutions and suggested to-be-resolved items. Relevant references and links to past information may be added. Auditors may validate such information and/or decisions may be adopted relatively quickly while having the full view of the matter at hand.
Customer communications—As discussed above, embodiments disclosed herein may be used in connection with differentiated marketing activities. Models may be differentially trained based on different data sets including customer communications (e.g., product reviews, web chat interactions, email, complaint submissions, focus group session recordings, etc.) and/or other data that provides potential customer insights for existing and prospective customers, potentially in combination with public data. Differential analysis techniques disclosed herein may be used to identify differences and/or insights in outputs generated by such differentially trained models.
Bidding—Corporations may prepare bids and proposals using past data and/or documents and using public and/or privately available information that is available. Trusted and/or otherwise managed generative AI engines consistent with various disclosed embodiments may provide a new document from past similar bidding and users can add information (and/or accept or reject information suggested by the generative AI engine). The legal document may be vouched versus past similar ones and/or highlight new terms and/or conditions (if any).
Knowledge Exchange—For certain industrial companies, their knowledge database may be difficult to read and/or search. Trusted generative AI engines consistent with various disclosed embodiments may provide a relatively quick reply to queries to a knowledge database based on direct questions and may refer to a specific technical document in a specific directory.
Exchange—Certain corporations may need to share their legal contracts, RFPs, and/or knowledge databases and/or portions thereof but may want to keep certain information private and/or confidential (e.g., personal information, financial data, etc.). Trusted generative AI engines consistent with various disclosed embodiments may, through query, provide requested information but tag information as “confidential” and/or the like that is not revealed without direct consent and/or renumeration/cost.
Sustainability, Education, and Community—Corporations may have industry knowledge that can be used in universities for educational purposes and/or shared with companies that have less chance to acquire the necessary knowledge to perform certain operations such as, for example and without limitation, governance, auditing of processes, and/or financial compliance.
Adaptability to a Dynamic Knowledge Base—In a corporate use case scenario, data labels may change very rapidly, perhaps in a matter of less than a day. For example, consider a case of a new product development program that has been maintained as a confidential project throughout a multi-year development cycle. In the day leading up to a major industry event, a press release announces the product, and suddenly the model (which has been trained over the course of thousands of documents and emails) must “un-learn” this labeling and make some (or all) of this information public. Embodiments of the disclosed systems and methods may allow for quick retraining of a model and manage who within the organization is given the appropriate permissions to re-classify information and/or what scope of information are they permitted to reclassify. Similar patterns may also be present in other types of corporate data, such as quarterly financial results, merger and acquisition announcements, etc.
Mixed Information Documents—Documents that are marked as confidential or proprietary may often contain non-confidential information for contextual purposes. When automated techniques are used to train a generative AI model as to which pieces of information are confidential, the sensitivity of these techniques to accidental mis-labeling, particularly in small data sets, may be considered. In some embodiments, a model may rely upon more heavily weighted “guidance documents” under the control of an appropriately privileged set of “training principals.”

### Dynamic Generative AI Model Selection Using Parameters

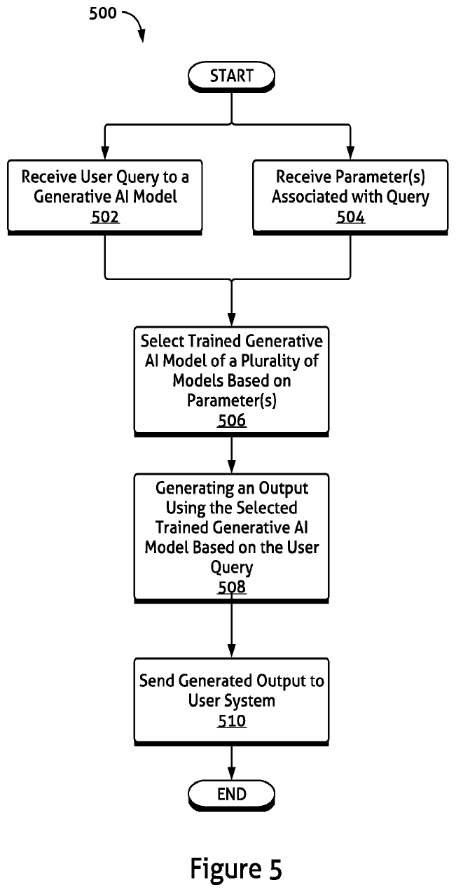

FIG. 5 illustrates a flow chart of a non-limiting example of a generative AI model query process 500 consistent with certain embodiments of the present disclosure. The illustrated method 500 may be implemented in a variety of ways, including using software, firmware, hardware, and/or any combination thereof. In certain embodiments, various aspects of the method 500 and/or its constituent steps may be performed by a generative AI service, an access management layer and/or service, and/or any other suitable application, system and/or service or combination of applications, systems, and/or services.

At 502, a user query for a response to be generated by a generative AI service may be received by the service. In some embodiments, the query may be received from a system associated with a user making the query. The generative AI service may further receive at 504 one or more parameters associated with the query. In certain embodiments, the parameters may be associated with the user making the query and/or an associated system. In further embodiments, the parameters may be associated with the query independent of any user and/or system making the query.

Consistent with embodiments disclosed herein, the one or more parameters may indicate an associated relative weighted reliance by the generative AI service on at least a portion of a proprietary data set when generating an output responsive to the user query. For example and without limitation, the parameters may indicate that a response generated by the service should be based entirely on the proprietary data set, be based on a subset of the propriety data set, be weighted equally between the proprietary data set and public data sets, be based entirely on a public data set, and/or any suitable combination or gradation of the same.

In various embodiments, the one or more parameters may be received separately from the user query. In further embodiments, the one or more parameters may be received as part of the user query. The one or more parameters may be associated with a querying user associated with the user query, a querying system, and/or the like.

In some embodiments, the one or more parameters may be received from an access rights management layer of the generative AI service, which may manage the parameter information and/or receive it from an access rights management service associated with the generative AI service and/or a separate service. In some embodiments, the parameter(s) may be associated with the querying user and may be managed in connection with a user access rights profile managed by the access rights management service. For example, when a user logs in to the access rights management service and/or the generative AI service, a profile associated with the user that includes the one or more parameters may be accessed, with the parameter information being provided to the generative AI service for use in implementing various aspects of the disclosed methods.

Consistent with embodiments disclosed herein, a trained generative AI model of a plurality of trained generative AI models managed by the generative AI service may be selected at 506. In various embodiments, the selected trained model may be selected based, at least in part, on the one or more parameters associated with the query. For example, in various embodiments, each trained generative AI model of the plurality of trained generative AI models may be associated with model information. The model information may indicate an associated weighted reliance of a model on the at least a portion of the proprietary data set during an associated model training process.

Selecting the trained generative AI model of the plurality of trained generative AI models may involve comparing the one or more parameters with the model information associated with each trained generative AI model of the plurality of trained generative AI models. For example, a model may be selected that is associated with model information that matches the one or more parameters associated with the query and/or querying user. In further embodiments, a model may be selected that is associated with model information that is within a defined threshold of the one or more parameters (e.g., a threshold set by the generative AI service, a rightsholder associated with at least a portion of the proprietary data set, and/or the like). In this manner, a trained model may be selected that is well matched to a particular query and/or associated parameter(s).

Although various examples and embodiments detailed herein are described as using models trained and/or selected based on relative weighted percentages of associated public and/or proprietary data training reliance, it will be appreciated that other more granular paradigms may also be used, potentially employing tagged and/or otherwise labeled data and/or queries. For example and without limitation, a plurality of models of be trained based on amalgamated data sets comprised of constituent data having certain labels (e.g., executive-level presentations, new product development initiative information, human resources information, forward-looking financial information, board-level information, and/or the like), queries may be issued with such data labeling (e.g., directly by a user and/or via applied rights management techniques), an appropriate model may be selected from available models, and responses may be returned from the selected model.

At 508, an output responsive to the user query may be generated using the selected trained generative AI model. The generated output may be provided to the user system at 510.

### Pre-Processing of Data Queries Using a Trained AI Model

In certain embodiments, a trained generative AI model may be used to pre-process queries using available rights information, which may be retrieved by an access rights management layer and/or associated system and/or service. The pre-processing trained model may receive the initial query, interpret the question in a context and, consistent with various disclosed embodiments, select an appropriate model among a plurality of models that has been trained on the information requested (e.g., product models and/or their advertised features) and has the appropriate access level privileges associated with the querying user.

In at least one non-limiting example of the above, a salesperson may be directed to a generative AI model that has been trained on released product information only, whereas a product developer with greater access to product information may have their query directed to a model that has been trained on both current and pre-release product information. The resulting output from the model to developer's query may be labeled so that the developer can identify what information is confidential or not. By pre-processing queries using a trained generative AI model, the risk of inadvertent leaks of sensitive information may be mitigated.

### Training Pipelines and Data Refresh Processes

In certain embodiments, refresh processes may be employed, where data that was previously designated as proprietary and/or otherwise confidential is queued for training in other models. In embodiments where differential model training may be employed, prior models may be retrained with and/or without the newly labeled data.

Training data pipelines for model(s) may be managed, at least in part, by an access rights management layer. For example and without limitation, permissions can be assigned to those that have the authority to designate data available for use in the training pipeline and/or to assign and/or un-assign labels to data in the training pipeline. Audit records may be recorded that preserve the history of which individuals authorized certain information to be used to train one or more model(s). If confidential information is inadvertently disclosed via a model query to unauthorized parties, the audit information may be analyzed to determine how and/or when certain data was inappropriately used to train the model and corrective actions may be taken to mitigate further disclosures.

### Differentially Trained Models and Personalized Medicine

In certain non-limiting examples and/or applications, various disclosed embodiments may be used in connection with model training based, at least in part, on confidential patient records and in personalized medicine contexts. Public data regarding medical conditions, treatments, trials, etc., and private data such as individual patient records and/or groups of patient records may be used to differentially train a plurality of models. Using various techniques described herein, an automated subset analysis for trails may be performed, which researchers may use to identify subgroups where a treatment is effective or non-effective.

In at least one non-limiting example, a first model may be provided to a “standard” model trained on public and/or otherwise non-confidential data sets. These public data sets may include, for example and without limitation, available medical database information including medical journals, textbooks, reports on medical trials, and/or the like.

One or more other models may be trained using one or more confidential data sets that may include a medical record(s) of a particular patient, a patient's family, and/or a specialized cohort that includes the patient, and/or the like, potentially in addition to the public data sets. Other information that may be used and/or otherwise be relevant to differential diagnosis such as home address, place of birth, and/or the like, may also be included in confidential data sets used to train models.

Prompts may be issued to the “standard” model and one or more of the enhanced models to identify differentiations from the standard of care that is likely to be output by the “standard” model. In many instances, personalized medicine involves departures from established standards of care when justified. When differences between the standard model and the one or more enhanced models are identified, a user may issue additional queries focusing on identified differences.

In certain embodiments, the enhanced models may be trained using weighted factors and/or tags for specific treatments, comorbidities, and/or other factors. Queries provided to the “standard” model and the one or more enhanced models can be structured to evoke statements in a response that can encourage attention by the model to parameters in the private data cohort that favor one type of treatment over another when generating outputs (e.g., a choice from alternative medicines) and/or may indicate special care, additional tests, and/or the like that could be more personalized to the treatment of a specific patient and/or a member of a given cohort.

Service and/or System Architecture

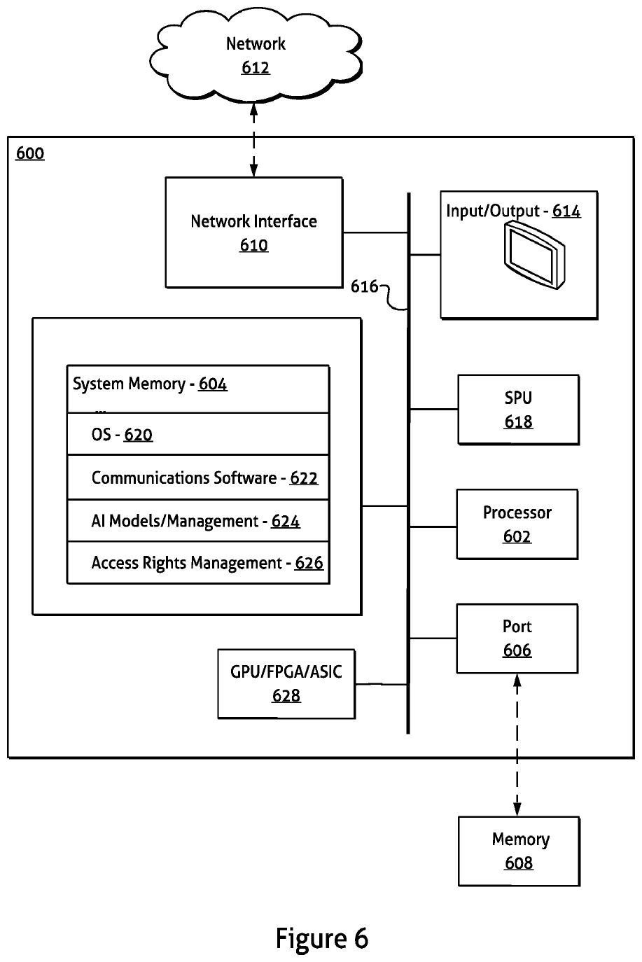

FIG. 6 illustrates a non-limiting example of a system 600 that may be used to implement certain embodiments of the systems and methods of the present disclosure. The system 600 of FIG. 6 and/or aspects thereof may be included in a system, service, and/or device associated with a generative AI service, an access management layer and/or service, a querying system and/or device, and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 612). In certain embodiments, the network 612 may comprise a variety of network communication devices and/or channels and may utilize any suitable communications protocols and/or standards facilitating communication between the systems and/or devices. The network 612 may comprise the Internet, a local area network, a virtual private network, and/or any other communication network utilizing one or more electronic communication technologies and/or standards (e.g., Ethernet or the like). In some embodiments, the network 612 may comprise a wireless carrier system such as a personal communications system (“PCS”), and/or any other suitable communication system incorporating any suitable communication standards and/or protocols. In further embodiments, the network 612 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards, 4G and/or 5G communication standards (e.g., Long-Term Evolution (“LTE”), 5G New Radio (“NR”), orthogonal frequency division multiple access (“OFDMA”), etc.). In certain embodiments, the network 612 may incorporate one or more satellite communication links. In yet further embodiments, the network 612 may utilize IEEE's 802.11 standards, Bluetooth*, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) 618 configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

In some embodiments, the system 600 may, alternatively or in addition, include a trusted execution environment and/or an SPU 618 that is protected from tampering by a user of the system or other entities by utilizing secure physical and/or virtual security techniques. A trusted execution environment and/or a SPU 618 can help enhance the security of sensitive operations such as personal information management, trusted credential, token, and/or key management, privacy and policy management, and other aspects of the systems and methods disclosed herein. In certain embodiments, the trusted execution environment and/or SPU 618 may operate in a logically secure processing domain and be configured to protect and operate on secret information, as described herein. In some embodiments, the trusted execution environment and/or a SPU 618 may include internal memory storing executable instructions or programs configured to enable the SPU 618 to perform secure operations, as described herein.

In various embodiments, the system 600 may further include one or more graphics processing units (“GPUs”), field-programmable gate arrays (“FPGAs”), and/or application-specific integrated circuits (“ASICSs”) 628 that may be used in connection with various generative AI training, analysis, and output generation processes consistent with various aspects of the disclosed embodiments. In some embodiments, the GPUs, FPGAs, and/or ASICs 628 may be general purpose in nature. In further embodiments, the GPUs, FPGAs, and/or ASICs 628 may be designed and/or otherwise configured for more specialized generative AI computing tasks.

The operation of the system 600 may be generally controlled by the processing unit 602, GPUs, FPGAs, ASICs 628, and/or an SPU 618 operating by executing software instructions and programs stored in the system memory 604 (and/or other computer-readable media, such as memory 608, which may be removable). The system memory 604 may store a variety of executable programs or modules for controlling the operation of the system. For example, the system memory may include an operating system (“OS”) 620 that may manage and coordinate, at least in part, and/or system hardware resources and provide for common services for execution of various applications.

The system memory 604 may further include, without limitation, communication software 622 configured to enable in part communication with and by the system, one or more generative AI model modules, services, and/or engines 624 and/or associated management services configured to perform various aspects of the disclosed embodiments, an access rights management layer and/or service 626 configured to perform various access rights management determinations and operations consistent with embodiments disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein but may be modified within the scope and equivalents of the appended claims.

1. A method for managing a generative artificial intelligence model query performed by a generative artificial intelligence service executing on a system comprising a processor and a non-transitory computer-readable storage medium storing instructions that, when executed by the processor, cause the system to perform the method, the method comprising:
receiving, from a user system, a user query for a response to be generated by the generative artificial intelligence service;
receiving one or more parameters associated with the query, the one or more parameters indicating an associated relative weighted reliance by the generative artificial intelligence service on at least a portion of a proprietary data set when generating an output responsive to the user query;
selecting a trained generative artificial intelligence model of a plurality of trained generative artificial intelligence models based, at least in part, on the one or more parameters associated with the query;
generating an output by the selected trained generative artificial intelligence model based, at least in part, on the user query;
sending, to the user system, the output generated by the selected trained generative artificial intelligence model.

2. The method of claim 1, wherein each trained generative artificial intelligence model of the plurality of trained generative artificial intelligence models is associated with model information, the model information indicating an associated weighted reliance of a model on the at least a portion of the proprietary data set during a model training process.

3. The method of claim 2, wherein selecting the trained generative artificial intelligence model of the plurality of trained generative artificial intelligence models comprises comparing the one or more parameters with the model information associated with each trained generative artificial intelligence model of the plurality of trained generative artificial intelligence models.

4. The method of claim 3, wherein the selected trained generative artificial intelligence model is associated with model information that matches the one or more parameters.

5. The method of claim 3, wherein the selected trained generative artificial intelligence model is associated with model information that is within a defined threshold of the one or more parameters.

6. The method of claim 5, wherein the defined threshold is set by the generative artificial intelligence service.

7. The method of claim 5, wherein the defined threshold is set by a rightsholder associated with the at least a portion of the proprietary data set.

8. The method of claim 1, wherein the one or more parameters are received with the user query.

9. The method of claim 1, wherein the one or more parameters are received from the user system.

10. The method of claim 1, wherein the one or more parameters are associated with a querying user.

11. The method of claim 10, wherein the one or more parameters are received from an access rights management layer of the generative artificial intelligence service.

12. The method of claim 10, wherein the access rights management layer receives the one or more parameters from an access rights management service.

13. The method of claim 10, wherein the one or more parameters are associated with a user access rights profile managed by the access rights management service associated with the querying user.

14. The method of claim 13, wherein the user access rights profile is identified based on log in information provided by the querying user to the generative artificial intelligence model services.

15. The method of claim 1, the method further comprises sending, to the user system, an indication of the model information associated with the selected trained generative artificial intelligence model.
